(19) United States
(12) Patent Application Publication
(10) Pub. No.: US 2017/0313439 A1
(43) Pub. Date: Nov. 2, 2017

(54) METHODS AND SYSTSTEMS FOR OBSTRUCTION DETECTION DURING AUTONOMOUS UNMANNED AERIAL VEHICLE LANDINGS

(71) Applicants: Jordan Holt, Hood River, OR (US); Steve Olson, Hood River, OR (US); Alex Barchet, Hood River, OR (US); Amit Dagan, Hood River, OR (US)

(72) Inventors: Jordan Holt, Hood River, OR (US); Steve Olson, Hood River, OR (US); Alex Barchet, Hood River, OR (US); Amit Dagan, Hood River, OR (US)

(21) Appl. No.: 15/142,956

(22) Filed: Apr. 29, 2016

(51) Int. Cl. B64D 45/08; B64C 39/02; B64D 47/08; G06K 9/00

(52) U.S. Cl. CPC B64D 45/08; G06K 9/0063; G06K 9/00711; B64D 47/08; B64C 39/024; B64C 2201/108; B64C 2201/141; B64C 2201/162

(57) ABSTRACT

Systems and methods for obstruction detection during autonomous unmanned aerial vehicle landings, including unmanned aerial vehicles equipped with at least one video camera, an image processor that analyzes a feed from the video camera to detect possible obstructions, and an autopilot programmed to abort an autonomous landing if it receives a signal indicating an obstruction was detected. In some examples, the systems and methods are in communication with a ground station to perform obstruction detection analysis instead of performing such processing on board the UAV. In some further examples, the landing area includes a ground-based visual target that the UAV can locate and home in upon from the air.

### BACKGROUND

The present disclosure relates generally to unmanned aerial systems. In particular, methods and systems for detection of obstructions within the approach path of unmanned aerial vehicles (UAVs) executing autonomous landings are described.

Unmanned aerial vehicles, like any aerial vehicle, run the risk of collision with objects in their flight paths. A collision between a ground object and a UAV will typically result in damage to the UAV and, depending upon the size of the UAV in question, possible damage to the struck object. When the object is a person or animal, severe bodily harm or death could result. Where a UAV is under continuous control from a ground operator, as is the case of most model aircraft, the ground operator is responsible for seeing possible obstructions and altering the UAV's course to avoid. In recent years, however, UAVs have gained autonomous flight capabilities to the point where a UAV can be preprogrammed with a mission comprised of a set of flight paths between waypoints, concluding with a landing at a predetermined landing spot. Thus, it is possible for a UAV to take off, fly, and land, without real time input or guidance from a ground operator.

Known landing systems for UAVs are not entirely satisfactory for the range of applications in which they are employed. For example, existing systems and methods typically do not provide object detection during an autonomous landing. Thus, the UAV operator must monitor a landing area for potential objects within the UAV's path and either clear the obstructions in a timely fashion, or take control of the UAV to manually avoid the obstructions. Where the operator cannot be present at the landing site during landing, the landing site must be secured in advance to avoid a possible obstruction collision. Furthermore, even clearing and securing a site in advance may not prevent unexpected incursions by unforeseen persons or animals.

Thus, there exists a need for systems and methods that improve upon and advance the design of known systems and methods for conducting UAV autonomous landings. Examples of new and useful systems and methods relevant to the needs existing in the field are discussed below.

Disclosure addressing one or more of the identified existing needs is provided in the detailed description below. Examples of references relevant to methods and systems for obstruction detection during an autonomous unmanned aerial vehicle landing include U.S. patent application Ser. No. 15/017,263, filed on 5 Feb. 2016, and directed to Visual Landing Aids for Unmanned Aerial Systems. The complete disclosure of the above patent application is herein incorporated by reference for all purposes.

### SUMMARY

The present disclosure is directed to systems and methods for obstruction detection during autonomous unmanned aerial vehicle landings that include an unmanned aerial vehicle equipped with at least one video camera, an image processor that analyzes a feed from the video camera to detect possible obstructions, and an autopilot programmed to abort an autonomous landing if it receives a signal indicating an obstruction was detected. In some examples, the systems and methods are in communication with a ground station to perform obstruction detection analysis instead of performing such processing on board the UAV. In some further examples, the landing area includes a ground-based visual target that the UAV can locate and home in upon from the air.

### BRIEF DESCRIPTION OF THE DRAWINGS

FIG. 1 is a perspective view of a first example of a system for obstruction detection during an autonomous unmanned aerial vehicle landing.

FIG. 2 is an overhead view from the system shown in FIG. 1 depicting the view from the camera on the system, including a landing target and designated landing zone.

FIG. 3 is a block diagram of the example system shown in FIG. 1 depicting the various active components used for obstruction detection.

FIG. 4 is a flowchart of an example method for obstruction detection during an autonomous unmanned aerial vehicle landing that could be implemented by the system shown in FIG. 1.

### DETAILED DESCRIPTION

The disclosed methods and systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various methods and systems for obstruction detection during autonomous UAV landings are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

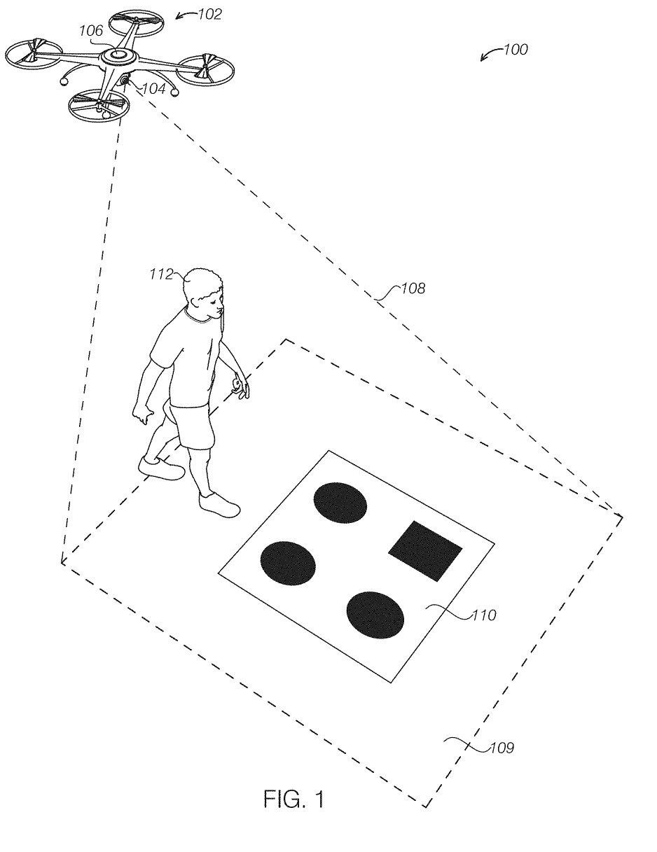

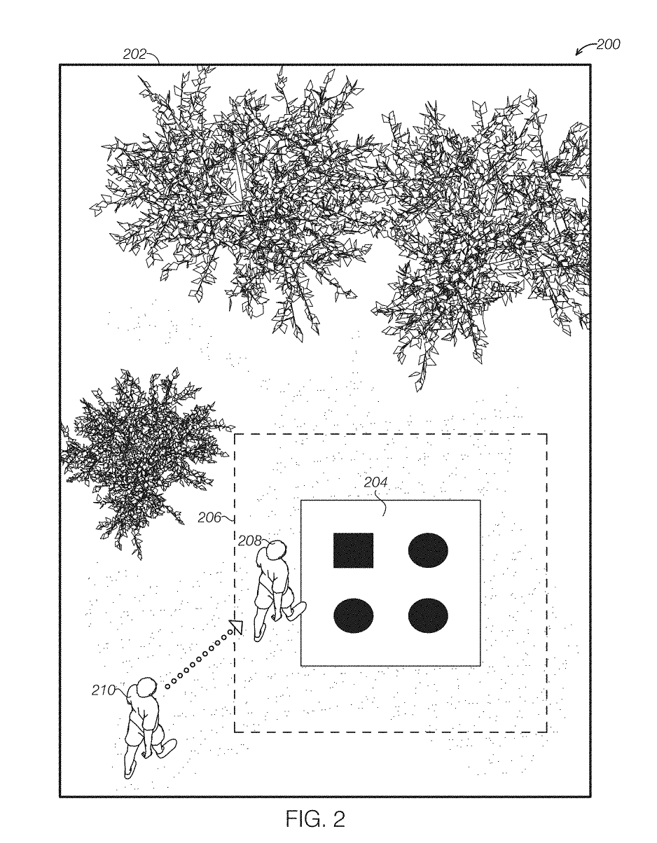

With reference to FIGS. 1-2, a first example of a system for obstruction detection during an autonomous unmanned aerial vehicle landing, system 100, will now be described. System 100 functions to provide monitoring of the landing area for an unmanned aerial vehicle as it executes an autonomous landing, to detect the intrusion of any obstacles within the landing zone for the UAV. The reader will appreciate from the figures and description below that system 100 addresses shortcomings of conventional methods of autonomous landing for UAVs.

For example, system 100 allows a UAV to continuously monitor a designated landing area during an autonomous landing procedure for possible obstructions, such as persons or animals, impinging upon the UAV's flight path. Collision can then be avoided upon detection by a variety of different approaches, such as holding for an obstruction to clear, or diverting to an alternate landing site or around the obstruction. Thus, potential damage to both the UAV and any ground obstructions can be avoided. Further, by providing obstruction detection capabilities, the UAV operator is freed from having to monitor the landing area, secure it, or even pre-clear it from obstructions.

System 100 for detecting an obstruction by an unmanned aerial vehicle 102 (UAV) during an autonomous landing includes at least one image sensor 104 on board UAV 102 that is capable of producing a video feed and possesses a field of view 108 that encompasses the target landing area 110. An image processing unit 106 is in data communication with at least one image sensor 104 so as to receive the video feed, wherein image processing unit 106 analyzes at least a portion of field of view 108 that encompasses target landing area 110 of the video feed using one or more object detection algorithms to detect an obstruction 112 within the flight path of the unmanned aerial vehicle 102. An autopilot is in data communication with image processing unit 106, and is programmed to abort the autonomous landing if an obstruction is detected.

As can be seen in FIG. 1, UAV 102 is depicted as a small aircraft, similar to a consumer drone like the DJI Phantom (www.dji.com) series of quadcopters. Although depicted as a quadcopter, it should be understood that any style of unmanned vehicle may be employed, including multirotor craft with more or less than four motors, single rotor conventional helicopters, or fixed-wing aircraft, including unpowered gliders as well as aircraft powered by one or more engines. The disclosed systems and methods can be implemented on any size of unmanned aerial vehicle capable of carrying the necessary image sensors and processing equipment, from micro-sized consumer drones to UAVs comparable in size to full-scale manned aircraft, including drones used for commercial purposes and by the military.

UAV 102 is preferably of a multi-rotor or single-rotor conventional helicopter format, or a similar style of aircraft that is capable of vertical take-off and landing (VTOL). However, it will be appreciated by a person skilled in the relevant art that the disclosed systems and methods could be easily modified to work with a fixed-wing aircraft or other UAV that lands conventionally or with short distances (STOL). As will be discussed further below, UAV 102 must be capable of executing an autonomous landing, where the UAV can approach and land in a predesignated location without input from a ground controller. Examples of autonomous landings can include the relatively primitive GPS-based return to home capability offered on the DJI Phantom and similarly equipped multirotors, where the UAV will fly back and land on a predetermined GPS location if the signal from the ground controller is lost, to UAVs that are capable of fully autonomous flight, and can be programmed to take off, fly a mission, and land without direct input from a ground station.

In the example shown in FIG. 1, UAV 102 is equipped with at least one image sensor 104 capable of outputting a video feed for use with image processing unit 106. Image sensor 104 may be dedicated to object detection during an autonomous landing phase, or may be additionally used in connection with first-person view (FPV) equipment or other mission equipment, such as an aerial photography, cinematography, or surveying camera. Furthermore, image sensor 104 may be comprised of a plurality of image sensors capable of detecting different types of light, each of which could feed into image processing unit 106 for enhanced target landing area detection in varying types of lighting.

The video feed is in the well-known format of a series of successive frames, and may use a compressed or uncompressed format. Examples of such video formats may include AVC-HD. MPEG4, DV, or any other video encoding format now known or later developed. Selection of a video encoding method may inform the selection of detection algorithms subsequently employed, or may require the video feed to be decompressed and/or decoded into a series of uncompressed successive frames. Image sensor 104 may be sensitive to infrared, ultraviolet, visible light, a combination of the foregoing, or any other type of electromagnetic radiation as appropriate to accurately detect and image target landing area 110. For example, where image sensor 104 can detect infrared light or is equipped with image intensifying equipment, low light or nighttime landings may be facilitated. Image sensor 104 may use CCD, CMOS, or any other suitable imaging technology now known or later developed.

Image sensor 104 provides a video feed constrained to a field of view 108 that depends upon the optics as well as the size of the imaging technology utilized with image sensor 104. During an autonomous landing, field of view 108 will encompass at least the target landing area 110, and preferably at least a safety buffer zone 109 that surrounds and includes target landing area 110. Field of view 108 may encompass beyond safety buffer zone 109, especially when UAV 102 is relatively distant from target landing area 110. As will be described further herein, those portions of field of view 108 outside of safety buffer zone 109 may be disregarded by image processing unit 106.

Referring to FIG. 2, an example of a field of view provided by image sensor 104, field of view 200, is depicted. Field of view 200 is bordered by frame 202, which constitutes the edge of the sensing device used in image sensor 104. Thus, frame 202 is the maximum extent of field of view 200. Within frame 202 is a target landing area 204, contained within a safety buffer zone 206. Safety buffer zone 206 is typically a subset of frame 202. It will be understood by a person skilled in the relevant art that as UAV 102 approaches target landing area 204, the proportion of frame 202 consumed by target landing area 204 and safety buffer zone 206 will increase. Depending on the angle of view provided by image sensor 104 and the distance between UAV 102 and target landing area 204, safety buffer zone 206 may fill the entirety of frame 202.

Safety buffer zone 206 (and its corollary 109) constitutes that portion of field of view 200 that image processing unit 106 monitors for obstructions. When a person is in position 208, inside of safety buffer zone 206, image processing unit 106 will signal the autopilot on UAV 102 to abort the landing. However, a person in position 210 will not be registered as an obstruction by image processing unit 106, until the person moves into position 208. Although safety buffer zone 206 is depicted as a rectangle in FIGS. 1 and 2, safety buffer zone 206 can be configured to be any shape, including a circle, triangle, trapezoid, polygon, or any other shape suitable to target landing area 204. Moreover, it is not strictly necessary to designate a safety buffer zone. Safety buffer zone 206 can be configured to be always contiguous with frame 202; in such a configuration, image processing unit 106 will register an obstruction any time a person or other object enters into the field of view of image sensor 104, defined as frame 202.

Target landing area 204 (and 110 in FIG. 1) is depicted as a square target with a series of circles and squares in a contrasting pattern placed thereupon. This target format was previously described in the above-referenced patent application directed to Visual Landing Aids for Unmanned Aerial Systems, and is tailored to be easily detected by image processing unit 106 using the disclosed algorithms in the above-referenced patent application. By using a fixed ground target for target landing area 204, safety buffer zone 206 can be determined with reference to target landing area 204. Moreover, the depicted target with its contrasting pattern can be used by image processing unit 106 to ascertain UAV 102 distance from target landing area 204. Use of the depicted target also can work in conjunction with object detection algorithms to ensure false positive detections are kept to a minimum, if not eliminated.

Alternatively, target landing area 204 can be implemented using a visual or optical landing target of a different style than those depicted in the patent application for Visual Landing Aids for Unmanned Aerial Systems, including existing ground features or spaces, provided such features can be distinguished from other features within field of view 200. Still further, target landing area 204 need not be implemented with a fixed ground target, but instead could be implemented using any guidance and/or navigation mechanism now known or later developed, such as GPS location, GPS-RTK location, a visual-based or radio-based beacon, radar signal guidance, or via any other navigational aid that allows UAV 102 to locate a predetermined target landing area. With any of the foregoing implementations, the autonomous landing is guided with reference to the implemented guidance mechanism. For example, where target landing area 204 is determined by a GPS location, UAV 102 will possess a GPS navigation device, which in turn supplies GPS guidance to the autopilot to guide the autonomous landing to the target landing area 204. Other guidance mechanism implementations will have UAV 102 equipped with corresponding guidance devices, such as radar signal generators, radio receivers, or other such equipment as appropriate to the technology used to determine target landing area 204. In such implementations, safety buffer zone 206 may be established with reference to the predetermined location in conjunction with a detected altitude.

Returning to FIG. 1, the video feed from image sensor 104 is fed into an image processing unit 106, which is in data communication with image sensor 104. Image processing unit 106 is capable of performing obstruction detection algorithms on at least a portion of the video feed, and communicating with the UAV's autopilot system to instruct it when to abort a landing. When a person 112 enters into safety buffer zone 109, the obstruction detection algorithm performed by image processing unit 106 senses the intrusion of person 112, and signals the autopilot of UAV 102 to abort the landing.

Image processing unit 106 is preferably implemented using a dedicated microcontroller which is sized so as to be placed on-board UAV 102. Suitable technologies may include a general purposes embedded microcontroller, such as Atmel's ATmega AVR technology or an ARM architecture processor, similar to the microprocessors used in many smartphones. Where such microcontrollers are used, image processing unit's 106 functionality is typically implemented in software, which is executed by the microcontroller. Other possible implementing technologies may include application specific integrated circuits (ASICs), where an integrated circuit or collection of integrated circuits are specifically designed to carry out the functionality required of image processing unit 106 at a hardware level.

Image processing unit 106 is in data communication with UAV's 102 autopilot. The autopilot in turn either provides flight control functionality, or interfaces with an inertial measurement unit or similar such device which provides flight control. The autopilot preferably handles autonomous flight mission tasks, such as interfacing with position sensors for directing UAV 102 along a predesignated course, and/or handling take-offs and landings. In this context, image processing unit 106 effectively comprises an additional position sensor providing flight data to the autopilot. The autopilot may be any suitable commercially available fight control system that supports autonomous flight capabilities. Alternatively, autopilot functionality could be integrated into image processing unit 106 to comprise a single unit that receives a video feed, detects obstructions, and controls UAV 102.

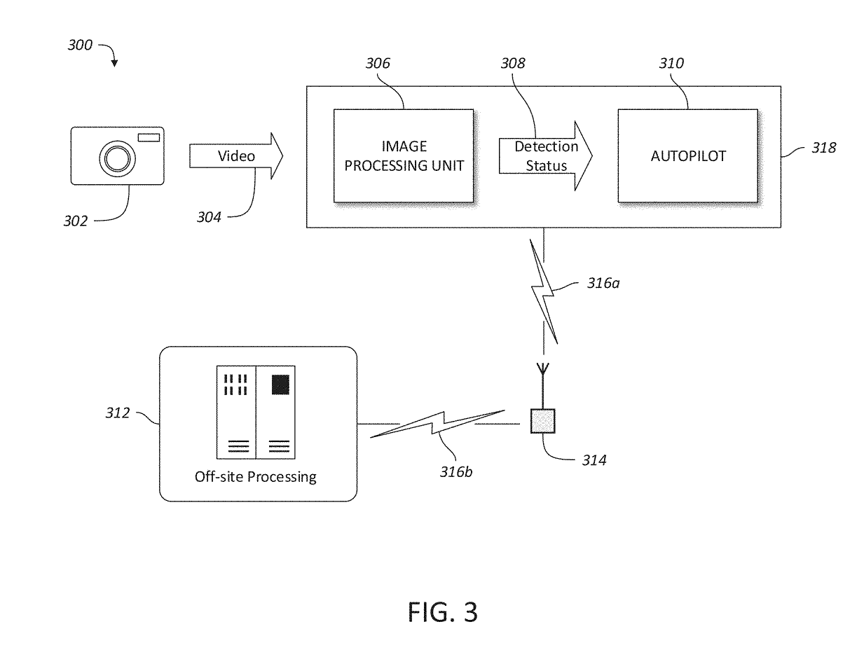

Turning attention to FIG. 3, a block diagram depicting the interconnection between the components of system 100, system 300, will now be described. System 300 includes image sensor 302 which communicates a video feed 304 to an image processing unit 306. Image processing unit 306 in turn is in communication with autopilot 310, so as to communicate a detection status 308. Box 318, surrounding image processing unit 306 and autopilot 310, represents the possible configuration discussed above where image processing unit 306 and autopilot 310 are implemented using a single device.

Image sensor 302 and image processing unit 306 each have similar functionality to image sensor 104 and image processing unit 106, described above. Likewise, video feed 304 is identical to the video feed described above that is generated by image sensor 104, and autopilot 310 possesses the functionality described above for the autopilot with reference to FIG. 1.

FIG. 3 demonstrates an alternate embodiment of the disclosed invention. System 300 includes off-site processing equipment 312, which communicates with image processing unit 306 and autopilot 310 via radio transceiver 314, which exchanges data over data links 316a and 316b. At least a portion of either data link 316a or data link 316b, or both, are implemented using wireless radio technology. Off-site processing equipment 312 can receive all or a portion of video feed 304 from image processing unit 306, and perform obstruction detection algorithms upon video feed 304. Following performance of the obstruction detection algorithms, off-site processing equipment 312 can transmit the detection status 308 back to autopilot 310. In this embodiment, then, obstruction detection is carried out separate physically separate from the UAV. Such an embodiment can be utilized where the implemented obstruction detection algorithms are too complex to be effectively carried out by image processing unit 306, and a greater amount of computing power can be provided by off-site processing equipment 312.

Radio transceiver 314 and associated data links 316a and 316b are implemented using any radio control link technology now known or later developed. Examples of such technology include DJI's Lightbridge data link, which is capable of communicating a video feed along with control information from a UAV to a ground station. Radio transceiver 314 will typically be implemented using a pair of transceivers, with one transceiver located on UAV 102 and in data communication with image processing unit 306 and autopilot 310, and a corresponding transceiver located on a ground station in data communication with off-site processing equipment 312. In this configuration, the pair of transceivers communicates bi-directionally using predetermined wireless frequencies and protocols. In addition to video feed 304 and detection status 308, data links 316a and 316b could be used to transmit control information to autopilot 310 for manual control of UAV 102, to upload mission parameters to autopilot 310 for autonomous flight, or to provide a location for a target landing area.

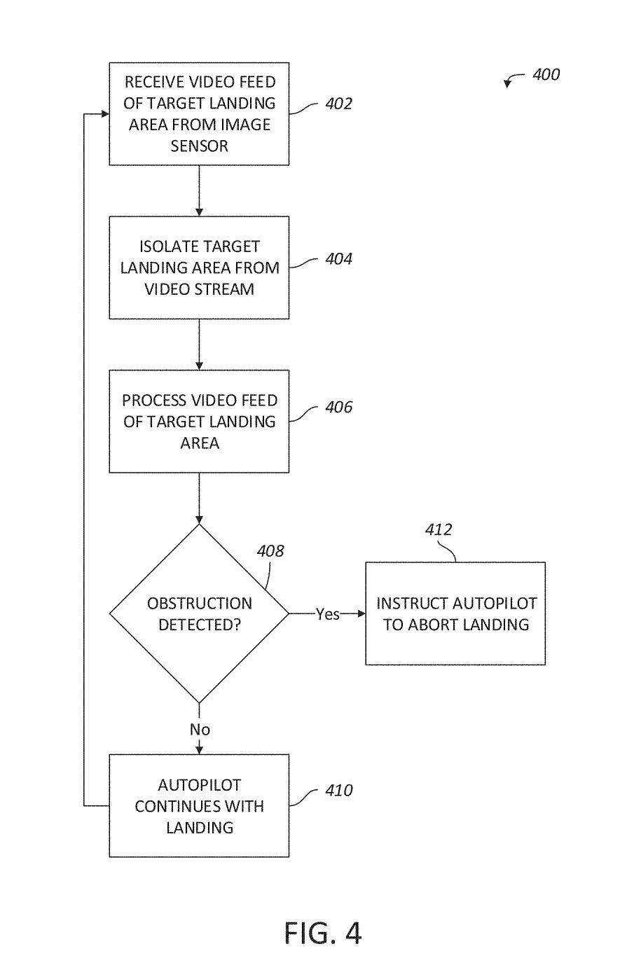

Turning attention to FIG. 4, a method 400 for detecting obstructions by an unmanned aerial vehicle during an autonomous landing to be implemented by systems 100 and 300 will now be described. Method 400 includes a step 402 of receiving a video feed of a target landing area from an image sensor on board the unmanned aerial vehicle, where the image sensor possessing a field of view that encompasses the target landing area. In step 406 at least a portion of the field of view that encompasses the target landing area of the video feed is processed using one or more object detection algorithms. In step 408, it is determined whether an obstruction within the flight path of the unmanned aerial vehicle to the target landing area is present. So long as no obstruction is detected, the UAV's automatic pilot will proceed to step 410, and continue with the landing procedure. Method 400 cycles back iteratively to step 402 following step 410, so that the target landing area is continuously analyzed for obstructions until landing is complete. If an obstruction is detected at any time, the landing is aborted in step 412.

Receiving a video feed of the target landing area from an image sensor in step 402 has been discussed above with reference to FIGS. 1-3. In step 406, the video feed including the target landing area is processed using an obstruction detection algorithm. Color histogram anomaly is the preferred obstruction detection algorithm; however, any known proprietary or commercially available detection algorithm can be used. Other examples may include motion or moving object detection, texture anomaly detection, 3D object detection, or any other algorithm now known or later developed that allows for object detection from a video feed. The selected algorithm may depend upon the camera used for the video feed. For example, 3D object detection requires either multiple cameras, or a single RGB-D camera that can provide depth estimates to various parts of the frame. Moreover, multiple algorithms could be implemented with the results compared so as to improve detection and reduce false positives. Furthermore, alternative sensors such as LIDAR can be used to potentially augment detection algorithms by verifying changes in depth for points within the safety buffer zone.

Step 404 can be optionally performed prior to step 406. Step 404 includes isolating and extracting from the video feed the safety buffer zone that includes the target landing area, to reduce the amount of video data that must be processed in step 406. Where the safety buffer zone is defined precisely as the target landing area, step 404 includes isolating the target landing area from the video feed and processing for obstructions.

As described above, at step 408 if an obstruction is detected within the safety buffer, the landing is aborted in step 412. If no obstruction is detected, the landing proceeds in step 410. Method 400 is an iterative process, being continually performed until the UAV finally lands. Accordingly, following step 410 method 400 cycles back to step 402. Typically implementations run steps 402 through 408 continuously while an autonomous landing is in process, with the autopilot executing the programmed landing unless an abort signal is received.

If an obstruction is detected, in step 412 the autopilot is instructed to abort the autonomous landing. Aborting the landing can be accomplished in a number of different ways. The selected way of aborting the landing can depend upon mission parameters, the size of the UAV involved, the altitude of the UAV, the remaining battery life of the UAV, and other similar parameters. For example, an abort signal may trigger the UAV to hold in position and wait until the safety buffer zone is cleared from the obstruction. Alternatively, the UAV may divert to a predetermined alternate landing site; in some instances, the alternate landing site can be designated as the UAV's point of takeoff. Still further, the UAV may revert to manual control and hold in place, awaiting further instructions from a ground controller. The UAV may also implement combinations of the foregoing, such as holding in place for a predetermined length of time before proceeding to an alternate site if the safety buffer zone does not clear within the predetermined length of time. In addition to aborting an autonomous landing, the UAV could be programmed to illuminate a landing light prior to aborting if a potential obstruction is detected either within the safety buffer zone or approaching the zone, in an attempt to alert the obstruction to the presence of the approaching UAV.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method for detecting obstructions by an unmanned aerial vehicle during an autonomous landing, comprising:
receiving a video feed of a target landing area from an image sensor on board the unmanned aerial vehicle, the image sensor possessing a field of view that encompasses the target landing area;
processing at least a portion of the field of view that encompasses the target landing area of the video feed using one or more object detection algorithms to detect an obstruction within the flight path of the unmanned aerial vehicle to the target landing area; and
aborting the landing if an obstruction is detected.

2. The method of claim 1, wherein the one or more detection algorithms comprise one or more of color histogram anomaly, texture anomaly detection, temperature blob detection, moving object detection, color detection of scene changes, multi-spectral anomaly, or 3D object detection using multiple cameras.

3. The method of claim 1, wherein the target landing area further comprises a landing target.

4. The method of claim 1, wherein processing at least a portion of the video feed is performed onboard the unmanned aerial vehicle.

5. The method of claim 1, wherein processing at least a portion of the video feed is performed on a facility separate from the unmanned aerial vehicle.

6. The method of claim 1, wherein aborting the landing further comprises revectoring to an alternate landing area.

7. The method of claim 1, wherein aborting the landing further comprises pausing the landing until the flight path is clear of the obstruction.

8. The method of claim 1, wherein autonomous landing in the target landing area is guided by an optical landing target, GPS, GPS-RTK, radio beacon, visual beacon, or radar signal.

9. The method of claim 1, wherein aborting the landing further comprises holding in place until receiving a manual override signal.

10. The method of claim 1, wherein portion of the field of view is defined as the area covered by a landing target and a safety buffer zone surrounding the landing target.

11. The method of claim 10, wherein the autopilot aborts the autonomous landing only if an obstruction is detected within the area covered by the landing target and surrounding safety buffer zone.

12. A system for detecting obstruction by an unmanned aerial vehicle during an autonomous landing, comprising:
at least one image sensor on board the unmanned aerial vehicle that is capable of producing a video feed and possesses a field of view that encompasses the target landing area;
an image processing unit in data communication with the at least one image sensor so as to receive the video feed, wherein the image processing unit analyzes at least a portion of the field of view that encompasses the target landing area of the video feed using one or more object detection algorithms to detect an obstruction within the flight path of the unmanned aerial vehicle; and
an autopilot in data communication with the image processing unit, wherein the autopilot aborts the autonomous landing if an obstruction is detected.

13. The system of claim 12, wherein at least the image processing unit and the autopilot are integrated into a single unit.

14. The system of claim 12, wherein the one or more object detection algorithms comprise one or more of color histogram anomaly, texture anomaly detection, temperature blob detection, moving object detection, color detection of scene changes, multi-spectral anomaly, or 3D object detection using multiple cameras.

15. The system of claim 14, wherein the at least one image sensor is comprised of a camera sensitive to visible light, infrared light, ultraviolet light, or a combination of any of the foregoing.

16. The system of claim 12, wherein the target landing area further comprises a landing target.

17. The system of claim 16, wherein the landing target is further comprised of one or more shapes that contrast with a background and are detectable by the image sensor.

18. The system of claim 17, wherein portion of the field of view is defined as the area covered by the landing target including a safety buffer zone.

19. The system of claim 18, wherein the autopilot aborts the autonomous landing only if an obstruction is detected within the area covered by the landing target including a safety buffer zone.

20. The system of claim 19, wherein aborting the autonomous landing includes revectoring to an alternate landing area, pausing the landing until the flight path is clear of the obstruction, returning to the unmanned aerial vehicle's point of take-off, or holding in place until receiving a manual override signal.
